(19) United States
(12) Patent Application Publication
(10) Pub. No.: US 2026/0175478 A1
(43) Pub. Date: Jun. 25, 2026

(54) MIX FOR THE PRODUCTION OF MICROPOROUS STRUCTURES

(71) Applicant: INNOSPIRE TECHNOLOGIES GMBH, Idstein (DE)

(72) Inventors: Ulrich MEYER-BLUMENROTH, Idstein (DE); Gisela JUNG, Wiesbaden (DE)

(73) Assignee: INNOSPIRE TECHNOLOGIES GMBH, Idstein (DE)

(21) Appl. No.: 19/125,600

(22) PCT Filed: Oct. 31, 2023
(86) PCT No.: PCT/DE2023/100800

§ 371 Date: Apr. 29, 2025

(30) Foreign Application Priority Data
Oct. 31, 2022 (DE) 10 2022 128 814.5

(51) Int. Cl. B29C 45/00; B29C 48/00; B29C 48/80; B29C 64/106; B29C 64/295; B29K 23/00; B29K 27/00; B29K 81/00; B29K 105/00; B29K 105/04; B29K 491/00; B33Y 10/00; B33Y 30/00; B33Y 70/00; C08J 3/12; C08K 5/3412

(52) U.S. Cl. CPC B29C 45/0001; B29C 48/022; B29C 48/802; B29C 64/106; B29C 64/295; C08J 3/12; C08K 5/3412; B29K 2023/12; B29K 2027/16; B29K 2081/06; B29K 2105/0067; B29K 2105/041; B29K 2491/00; B29K 2995/0093; B33Y 10/00; B33Y 30/00; B33Y 70/00

(57) ABSTRACT

An easy-to-handle ready mix of a polymer preparation, such as for producing porous or microporous structures, is presented, comprising a polymer substrate and a diluent, wherein the components of the polymer preparation intermesh in a delivery state of the ready mix in such a way that they are inseparably bonded to one another.

### FIELD OF THE INVENTION

The invention relates to a ready mix and its use for the production of microporous structures or elements having microporous structures.

### BACKGROUND AND GENERAL DESCRIPTION OF THE INVENTION

Microporous polymer membranes can be used in many separation processes. For example, in the production of milk powder for concentrating whey protein before spray drying, in biotechnology for separating cells and cell fragments from fermentation broths, for separating germs in drinking water treatment or for cleaning process media in technical processes.

There are already established processes for the production of polymer membranes. In the NIPS process (Non solvent Induced Phase Separation), for example, a polymer is dissolved in an organic solvent, applied to a nonwoven fabric as a thin layer or spun as a hollow thread or thin tube. In contact with a non-solvent, often water, the polymer precipitates as a microporous structure. In contrast, in the TIPS process (Thermal Induced Phase Separation), precipitation takes place by lowering the temperature of the polymer solution. The polymer is completely dissolved at an elevated temperature, e.g. 200° C. The solubility of the polymer in the solvent/diluent is greatly reduced at lower temperatures, e.g. 160° C., so that phase separation occurs during cooling when the cloud point is reached, with the formation of microporous structures. The porous areas are thereby connected to each other.

For example, patent specification DE 2 833 493 C3 shows the production of microporous hollow filaments using the TIPS process. In this process, molten polymer is mixed with a liquid solvent or solvent mixture in a dynamic mixer while still in a liquid state. A dosing pump conveys the mixture to an extrusion nozzle, through which a hollow thread or a thin tube can be formed. There are several disadvantages to this approach. For example, the mixing ratio between polymer and solvent must be set manually and is also subject to deviations of the respective pumps. These pump deviations typically add up to a conveying error, so that the finished product can exhibit relatively large fluctuations in terms of the number of pores, pore size and pore composition, as even small deviations in the composition of the starting material can result in considerable changes when microporous structures are formed. Exact specifications of the filter performance are therefore not possible. These deviations are particularly pronounced when only small delivery rates are required, as the absolute size of the pump error is always related to the maximum delivery rate, so that the relative error increases above average with smaller delivery rates.

A further disadvantage of the solution shown in DE 2 833 493 C3 concerns the complexity of the system, which—also due to the regularly differing delivery rates of the pumps—requires a high degree of process know-how to operate so that such a system can only be operated by a few trained employees and requires constant monitoring and adjustment of the process parameters.

The German publication DE 32 05 289 A1 on the other hand deals with the production of porous bodies with adjustable total pore volume, adjustable pore size and adjustable pore wall. There it is proposed to use a liquid “A” (castor oil, soybean oil or palm kernel oil) to form porous bodies with a polymer. The liquid “A” serves as the “bath liquid” of a spinning tube, which is kept at a temperature below the phase separation temperature. The bath liquid is passed through the spinning tube in the same direction as the polymer. In other words, a polymer is immersed in a bath of liquid A. Furthermore, it is a mandatory continuous process that cannot be interrupted or changed. This inline melting is therefore a very complex direct process with a bath liquid A, which requires a complex process setup and experienced process engineers to monitor the continuous mixing process, which can change spontaneously. If, for example, the pumping capacity of the bath fluid changes (which is frequently observed in practice), the body to be produced is unsuitable because the pore size has been set incorrectly. However, this can only be determined after production has been completed. The manufactured body is then ready for disposal. Monitoring the mixture is very difficult. Changes in the mixing ratio, which are easily set by changing process parameters, cannot be detected. Precisely defined pores are therefore impossible or difficult to achieve. Furthermore, an adjustable change of the mixing ratios between the polymer and the bath liquid is not possible or requires extensive process know-how on the part of the user. Different pores in one and the same body, which could be predefined in advance, cannot be realized with the process shown in DE 32 05 289 A1.

On the other hand, filaments based on polypropylene (PP) mixed with polyvinyl alcohol (PVA) are commercially available. Even when melted, the two polymers do not form a homogeneous solution and form a kind of emulsion. When solidified at room temperature, this preparation exists as a compound or polymer blend. Using a suitable 3D printer, pipe sections can be printed using the FDM process. The water-soluble parts of PVA can be extracted with hot water. It can be observed that the pipe sections expand by up to 20% in the axial direction (z-axis, perpendicular to the printer plane) during extraction. This behavior can lead to problems such as distortion or breakage of the component in the case of complex components consisting of two materials, for example. In combination with pure PP, which practically does not expand on contact with hot water, component areas made of these two materials might separate from each other unintentionally. As a result, these components are usually unusable.

The task of the present invention can therefore be seen in providing a method and a device with which an improved or modified production of components or objects with porous or microporous regions is made possible. In other words, such components or objects may be preferred which, on the one hand, exhibit porous or microporous regions and, on the other hand, exhibit non-permeable regions which are constructed integrally with the porous or microporous regions. Alternatively, components that exhibit an adjustable porosity.

In a partial aspect or further development of the invention, it can be regarded as an aspect of the task to provide a device and a method in which the aforementioned disadvantages are taken into account or eliminated.

Thus, in yet another partial aspect or further development of the invention, the task may be to provide a device and a method by means of which a constancy of the component properties with regard to the filter performance or the pore sizes can be achieved. In a further partial aspect, the present invention can solve the problem that it may no longer be necessary to operate the system under the constant supervision of trained specialist personnel. In yet another partial aspect, the invention can solve the problem of requiring less effort or being more cost-effective than known systems, so that advantages also result from this.

The problem is solved by the invention defined in the independent claims. Dependent claims provide further developments and preferred configurations of the invention.

In order to solve one, several or all aspects of the problem presented, an easy-to-handle ready-to-use mixture of a polymer preparation is proposed, especially for the production of porous or microporous structures. The ready mix comprises a polymer substrate and a diluent. The diluent is provided, for example, as a solvent or diluent. In a delivery state of the ready mix, the components of the polymer preparation are provided in such a way that they interlock so that they are inseparably bonded to one another. For example, the ready mix is provided in such a way that a comparatively large batch of liquid polymer substrate is mixed with liquid diluent, producing a homogeneous solution. The homogeneous solution can then be cooled so that a homogeneous solid mass can be provided in a reservoir without separation from the solution. This cooled solid mass can then be reduced to a desired form, for example granulated. The homogeneous solid mass can also be provided as a filament, for example.

In other words, a significant advantage of the ready mixed polymer preparation presented here is that the ready mix is particularly premixed in the delivery state and thus a porosity that can be built up from it is already preset without the need to monitor the large number of process parameters. Furthermore, the ready mix is particularly advantageous in a solid state. This ensures easy handling, it can be transported and made available for later processing in handy portion sizes for a production plant. Such a production plant can be a single, small 3D printer or a small extrusion or spinning system that does not require any special structures, for example for storing or providing a melt. This means that a premixed product is available for the production plant. As the ready mix is premixed and can therefore be used directly for production as a single-component base without the need for premixing in the production plant, the corresponding process steps of separate heating, control and adjustment of the corresponding pumps and conveying equipment as well as the corresponding equipment can be omitted in the production plant. The associated process know-how no longer needs to be maintained by the user of the production plant. Instead, the ready mix can be fed into the production plant and the user can rely on the fact that the desired production tolerances can be maintained.

For example, the polymer substrate in the ready mix is already adjusted in such a way that porous or microporous areas are formed in it, which are filled with a diluent-rich phase. This improves the “interlocking” of the polymer substrate with the diluent to form a stable—also mechanical—bond, which is only removed when the ready mix is transferred into a solution. The solution obtained from the ready mix is always immediately homogeneous, as the diluent is located between the polymer substrate and is incorporated directly into the solution during melting. A complex mixing of the solution can therefore be omitted if necessary.

The polymer preparation can be adjusted so that it is in the solid state at room temperature, for example in the range below 50° C., preferably in the range up to 75° C. or less, more preferably in the range up to 100° C. or less. The polymer preparation can furthermore be adjusted so that it forms a solution, such as a homogeneous solution, at an elevated temperature, the elevated temperature being, in case of an example, 70° C. or more, further preferably 90° C. or more, still more preferably 120° C. or more.

The porous or microporous regions of the polymer preparation in the ready mix exhibit an average pore size. The average pore size of the porous or microporous regions is preferably 5 μm or smaller, more preferably 1 μm or smaller, still more preferably 0.5 μm or smaller.

The polymer substrate and/or the polymer preparation of the ready mix is preferably hydrophobic and/or set up in such a way that water is only incorporated in small quantities. For example, the compound with polypropylene and polyvinylidene fluoride is hydrophobic. Polyethersulfone with ε-caprolactam, on the other hand, is typically hydrophilic per se and is typically extracted with water. However, as could be observed, the water retention is only slight and only results in a slight expansion of the component.

Furthermore, the polymer substrate and/or the polymer preparation of the ready mix can be adjusted in such a way that a transfer of the ready-placed ready mix into a final product causes only slight swelling, be it a temporary swelling of the final product during its manufacture or a permanent swelling which results in a larger dimension of the final product, for example a greater length. Thus, it may be preferred that a swelling of the polymer preparation in at least one direction, preferably in all directions, of at most 10% of the original size or less is caused, preferably 5% or less, more preferably 3% or less. In this way, strains and any associated cracks can be avoided, particularly during manufacture. For example, the diluent can be washed out after the product has hardened. The diluent may initially absorb a small amount of the washout agent. However, it is not desirable for the diluent to absorb the washout agent to a large extent, as this can lead to an enormous change in length or swelling in one or more directions. This can be ideally prevented by keeping the ready mix according to the invention ready for the respective process, as the swelling can also depend on the exact mixing ratio between the polymer substrate and the diluent.

Drying an article produced from the ready mix may further cause shrinkage of the article, which is, e.g., at most 10% of the original size or less, preferably 5% or less, more preferably 3% or less. For example, the shrinkage may be of a similar order of magnitude to the previously described swelling of the article, so that the article produced from the ready mix has approximately the same material volume or body volume as the polymer preparation provided in the ready mix and changes in volume or length throughout the manufacturing process are less than at most 10% or less in terms of material volume, preferably 5% or less, more preferably 3% or less.

The polymer preparation may further comprise an organic or inorganic additive.

The polymer substrate may comprise polypropylene, polyethersulfone or polyvinylidene fluoride, or a mixture thereof, the list being non-exhaustive. The diluent may comprise soybean oil, castor oil, carnauba wax, ε-caprolactam, or a mixture thereof, the list being non-exhaustive.

The polymer preparation may comprise polypropylene as polymer substrate in a mass fraction of at least 20 m %, preferably at least 35 m %, more preferably at least 50 m %, and/or of up to 40 m %, preferably of up to 55 m %, more preferably of up to 65 m %. The polymer preparation may alternatively or cumulatively comprise polyethersulfone in a mass fraction of at least 10 m %, preferably at least 20 m %, more preferably at least 30 m %, and/or of up to 25 m %, preferably of up to 35 m %, more preferably of up to 45 m %. The polymer preparation may alternatively or cumulatively comprise polyvinylidene fluoride in a mass fraction of at least 15 m %, preferably at least 25 m %, more preferably at least 35 m %, and/or of up to 30 m %, preferably of up to 40 m %, more preferably of up to 50 m %.

The diluent may comprise a mixture of soybean oil with castor oil in a mass fraction of at least 50 m %, preferably at least 65 m %, more preferably at least 80 m %, and/or of up to 85 m %, preferably of up to 70 m %, more preferably of up to 55 m %. The diluent may alternatively or cumulatively comprise carnauba wax in a mass fraction of at least 50 m %, preferably at least 65 m %, more preferably at least 80 m %, and/or of up to 85 m %, preferably of up to 70 m %, more preferably of up to 55 m %. The diluent may alternatively or cumulatively comprise ε-caprolactam as diluent in a mass fraction of at least 65 m %, preferably at least 80 m %, more preferably at least 90 m %, and/or of up to 95 m %, preferably of up to 85 m %, more preferably of up to 75 m %.

It was found that the polymer preparation, stored as granules or filament, with a mixture of 35% polypropylene and 65% soy/castor oil mixture does not form any oil precipitates or secretions up to a temperature of 110° C. and/or during long storage. In other words, it was found that the ready mix polymer preparation in the form described here has a stable shelf life.

The present description also covers the provision of the ready mix as described above in one of the following advantageous forms. For example, the ready mix may be provided as granules, powder, flakes, filament, melt cartridge, a cartridge or for use in a drum melter. In other words, the provision of the premixed ready mix, particularly in the solid phase state, allows a variety of forms of provision, each of which can be adapted to a particularly suitable or particularly cost-effective form. An example of this is the drum melter form, in which the solid product can even be left in the preparation pot from the preparation of the ready mix; it can be solidified directly there. The ready mix is then melted in portions or slices by the heating device immersed in the drum from above and fed to the production plant. In fact, only the amount of ready mix that is required for actual production needs to be melted, or only a small excessive part of it. The rest remains in a solid phase in the drum, so that this is also particularly energy-saving.

The present description also covers a method for producing an easily handled ready mix of a polymer preparation. The method comprises the steps of mixing a polymer substrate with a diluent to provide a polymer-diluent mixture, heating the polymer-diluent mixture to a temperature above the melting temperature of the diluent. In a particularly preferred embodiment, the melting temperature of the diluent is lower than the melting temperature of the pure polymer substrate, whereby the diluent is suitable for melting the polymer substrate at its melting temperature, or at least below the melting temperature of the polymer substrate. This enables further energy savings already during the production of the ready mix, since heating is only necessary to the melting temperature. Of course, the present description also covers the heating of the polymer-diluent mixture to a temperature above the melting temperature of the polymer substrate.

The method further comprises dissolving the polymer-diluent mixture to provide a homogeneously dissolved polymer preparation. Typically, this means that the polymer-diluent mixture is heated to a temperature higher than the melting temperature of the diluent and/or the polymer substrate.

The cooling of the polymer preparation below a solidification temperature is preferably carried out afterwards, i.e. when the homogeneous solution has been adjusted so that the homogeneous solution solidifies.

The solidified polymer preparation can then be portioned, for example by granulation, or by grinding it into a powder, or by flaking, by rolling up the filament and separating it into manageable sizes, by finishing the respective melt cartridge, or by sealing or otherwise finishing a cartridge. When used for a drum melter, portioning takes place, for example, with or before mixing or dissolving, as the prepared mixture can already be preset in the drum and a manageable quantity is introduced into the drum.

The present description also comprises a method for producing a component from a ready mix comprising the steps of providing a ready mix, such as described above, heating in any case one portion of the ready mix to a temperature above the melting temperature of the diluent and/or the ready mix and thus providing a homogeneously dissolved polymer preparation, extracting the homogeneously dissolved polymer preparation and thereby building up the component, such as in monolithic construction, further as an example by means of additive manufacturing. The stable, storable ready mix has already been successfully used to produce corresponding microporous components. In terms of handling, it has proven to be extremely user-friendly and easy to use compared to previous processes using a bath liquid. A process engineer is no longer required, as there is no longer any step needed to continuously adjust and monitor the mixing ratios. Instead, the ready mix, for example in the form of granules or filaments, always provides a consistent mixing ratio.

During the construction of the component up to its completion, a change in volume or length caused by foreign matter of at most 10% of the original size, preferably of at most 5% or less, more preferably of 3% or less, can be set.

The present description also comprises a system for producing components from a ready mix, such as described above or using one of the methods described above, comprising a ready mix reservoir for easy provision of the solid ready mix, a heating device for heating in any case one portion of the ready mix above the melting temperature of the diluent. The system also includes a placement device for setting up the component. For example, this can be an extruder or a filament transport device.

The ready mix can be provided in the system as granules and/or as a melting cartridge. The ready mix reservoir can be provided as a drum. The heating device can be prepared to dip into the ready mix reservoir as a drum melter. The ready mix can also be provided as a filament and the heating device can be provided as a continuous melter.

The present description also covers a component which is manufactured from the ready mix described above and/or according to one of the processes described above and/or using the equipment described above.

Thus, the invention presented herein is capable of providing a finished mixture (preparation) of polymer(s) and diluent(s) which are in solid form at room temperature and thus easy to handle. The preparations can be produced in various forms, the following appearing to be of particular interest:
Granules
Powder
Flakes
Melting cartridge
Melting cartridge for drum melter
Filament

This is because the materials can be easily processed in these forms using currently available technologies. For example, a simple extruder or drum melter is sufficient to produce hollow filaments or flat membranes using suitable extrusion tools. The complex production of the mixture from at least two components is no longer necessary. This also greatly simplifies the start-up and shut-down of the extrusion system. The provision as filament or granulate is what makes it easy to use in additive manufacturing. In all cases, the extraction of the diluent phase is simple and associated with minimal swelling, as the diluent systems consist mainly of low-molecular components. The resulting microporous structure consists of interconnected pores.

The preparations described in the present description are homogeneous solutions at temperatures at which the mixture is liquid. The components of the ready mix therefore do not form an emulsion or a blend, but mix homogeneously and completely. This allows smaller pores to be produced. At less than typically 3%, swelling during extraction is also considerably lower than with the PP/PVA polymer blend described at the beginning. Furthermore, there is no anisotropic swelling or even differences in different directions or are at 3% or less during the extraction/swelling ratio. The lower molecular weight of the diluents used in the present description also plays into the cards here.

Specific examples of usable, tested and found to be very useful fabric systems include, firstly, a blend with polypropylene (polymer substrate) and soybean oil/castor oil (diluent), typically in a ratio of 35% polypropylene and 65% soybean oil/castor oil. In a second example, this may comprise polypropylene (polymer substrate) with carnauba wax (diluent), with typically 35% polypropylene and 65% carnauba wax. In a third example, this may comprise polyethersulfone with ε-caprolactam with typically 20% PES and 80% ε-caprolactam. In a fourth example, this may comprise polyvinylidene fluoride with ε-caprolactam with typically 25% PVDF and 75% ε-caprolactam. For the sake of good order, it should be added that the skilled person will recognize that the specific examples described in this paragraph are not limited to the particular specific number, but variations in composition are possible and are encompassed by the present description. Elsewhere in this description, examples of lower and upper limits of compositions of matter are given which are also applicable to this paragraph.

Another advantage is the greater accuracy of the composition or the improved reproducibility of mixing results. For example, the diluent quantity does not result from the difference between the different delivery rates, for example of a melt pump and a dosing pump. These errors can lead to undesirable deviations in the composition of the polymer-diluent mixture, especially with small dosing quantities. When microporous structures are formed, even small deviations in the composition of the mixture can lead to considerable changes in the microporous structure. In the method according to the invention, the production of the polymer-diluent mixture is separated in time and space from the dosing or application of the molten mixture. This allows the optimum adjustment of the mixing ratios without having to take into account a subsequent extrusion or spinning process.

The material of the ready mix according to the invention can, aside from strand extrusion and melt spinning, also be used in the injection molding process (single and multi-component injection molding). Especially with the injection molding process, complex filter structures can be produced cost-effectively. Components with porous and non-porous areas or with differently porous areas in the same component can also be produced relatively easily in multi-component injection molding by providing several differently composed ready-mixes simultaneously or successively. All in all, the provision of the ready mix according to the invention and described in detail here alone is seen as having enormous potential for further development in this field of work.

The injection molding process or injection molding, just like 3D printing, is a discontinuous process that can be carried out with the Ready Mix (polymer ready mix) presented here—in contrast to conventional inline processes, which can only be operated continuously. One could say that the Ready mix (polymer ready-mix) offers a “melt-on-demand” for the production of porous structures, in which only the portion or amount of material that is required for the construction of the subsequent component—or even only areas or parts of the component—has to be prepared in molten form. Thus, a low-permeability zone can be created in a component with a first ready mix, then a second ready mix—e.g. a different filament—can be inserted and this can be further processed on the same component. The further filament or the second ready mix can thus be processed, especially in one-piece or monolithic construction, with which a highly permeable zone is built up. The present invention thus also provides a novel way of operating a discontinuous process, such as in the form of injection molding, 3D printing or melt-on-demand, for building a component with porous structures.

The present description therefore also encompasses a discontinuous method for producing a component from a ready mix, comprising the step of providing a first portion of the ready mix, such as described in detail above. The ready mix can be provided by filling the first portion of the ready mix, for example granules, for example into a first storage container. Furthermore, the step of heating the first portion of the ready mix to a temperature above the melting temperature of the diluent and/or the ready mix and thus providing a first completed quantity of homogeneously dissolved polymer preparation is included. A first area of the component to be built up is built up in an assembly step with the first completed quantity of homogeneously dissolved polymer preparation. When the first portion of the ready mix is consumed, or while the first portion of the ready mix is being consumed, a further portion of the same ready mix or a portion of a further ready mix is provided. The further portion is heated to the temperature above the melting temperature of the diluent and/or the ready mix, thus providing a second completed quantity of homogeneously dissolved polymer preparation. Afterwards, a second area of the component is built up with the second completed quantity of homogeneously dissolved polymer preparation. This sequence can be repeated again and again, namely that a further portion or completed quantity of homogeneously dissolved polymer preparation is provided and processed consecutively until the component is finally completed, such as in monolithic, i.e. one-piece, construction.

For the purposes of the present description, the provision of the first portion of the ready mix and the provision of the second portion of the ready mix can interlock in the method or system. For example, the second portion of the ready mix may be filled into a template while the remainder of the first portion of the ready mix is still being removed therefrom. Alternatively or cumulatively, it is possible that the first portion of the ready mix cannot be completely removed from the template, for example because residues adhere to the walls of the template and these residues mix with the second portion. However, this does not represent a transition to a continuous process, even if this results in a continuous material flow at the material application nozzle. This is because the raw material, i.e. the ready mix, can be refilled or fed discontinuously. In other words, the discontinuous process sets itself apart from the continuous process in that the raw material (here: the ready mix) does not have to be fed or provided in a constant and continuous material flow into a system (e.g. the feeder). Rather, the provision can be interrupted, i.e. discontinuous, and can, for example, take place in individual, separate portions. Such portioning, in which a constant material composition of the polymer preparation can always be provided in the most advantageous way, can be easily carried out by modern digital machines. Monitoring the no longer existing continuous material supply flow is omitted.

The discontinuous process can be carried out by means of extraction of the homogeneously dissolved polymer preparation and/or in monolithic construction. The discontinuous process can also be designed as an injection molding process, 3D printing, melt-on-demand or a combination of the aforementioned.

In the following, the invention is illustrated in more detail by means of embodiments and with reference to the figures, whereby identical and similar elements are in some cases provided with the same reference symbols and the features of the various embodiments can be combined with one another.

### BRIEF DESCRIPTION OF THE FIGURES

It shows:

FIG. 1 A schematic structure of a device for processing the ready mix,

FIG. 2 a schematic process diagram showing the production of the ready mix, its subsequent use and the production of a component from the ready mix,

FIG. 3 a further embodiment of a device for processing the ready mix with two material supplies,

FIG. 4 FIGS. 4A, 4B and 4C show three component sections of components manufactured according to the invention with porosity adjusted according to the invention.

### DETAILED DESCRIPTION OF THE INVENTION

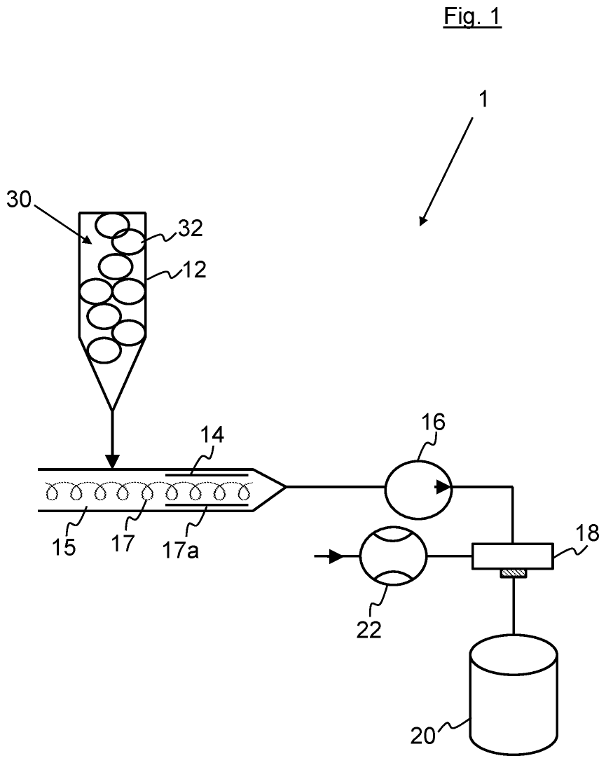

FIG. 1 shows an example of a spinning system 1 for the production of an object 20 according to the invention. A preparation or ready mix 30 according to the invention, e.g. based on polypropylene, here as granules 32, is fed from a storage container 12 to an extruder 14 and melted there. A screw conveyor 15 can be arranged in the extruder 14, which for example comprises the heating device 17, so that inline heating is formed. Alternatively or cumulatively, the extruder 14 can also have a heating device 17a on the outside or on its outer walls. In yet another alternative, for the sake of completeness, the ready mix 30 can also be heated in the storage container 12 and fed to the extruder 14 in liquid form. A solution is thus formed from the ready mix 30 in the extruder 14 at the latest. A dosing pump 16 feeds this solution to an extrusion nozzle 18, which is designed to form a hollow thread or a thin tube 20. A supporting fluid, in this case N₂, supplied in a controlled manner via a flow meter 22, prevents the extruded hollow filament or tube 20 from collapsing. Cooling causes segregation (phase separation) in the wall of the extruded hollow filament or tube 20.

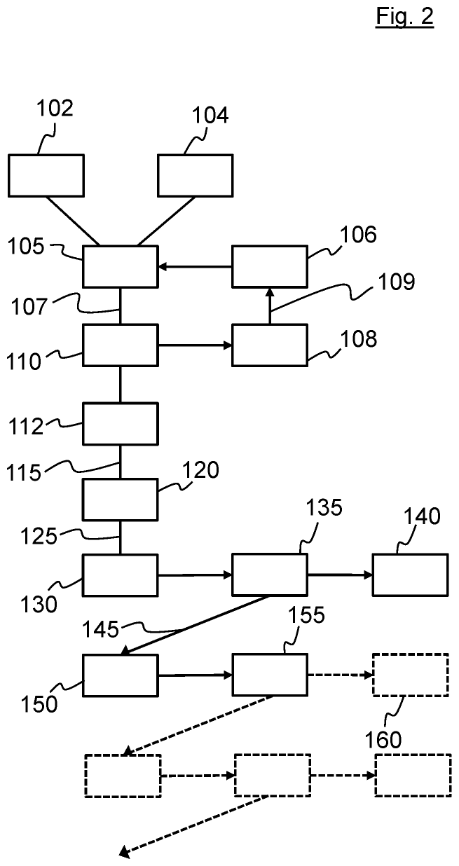

FIG. 2 shows a schematic process overview of a process sequence. First, the polymer substrate 102 and the diluent 104 are brought together to form a polymer-diluent mixture 105. Thermal energy 106 is supplied to the polymer-diluent mixture 105, for example by means of a heating device, and the polymer-diluent mixture 105 is gradually fed to a melting step 107. Alternatively, the polymer substrate 102 may be melted separately from the diluent 104 and both components may be mixed in liquid form. However, there may be advantages to melting the polymer-diluent mixture 105, for example if a lower melting point is formed for the mixture as a whole. This may be the case if the diluent 104 has a lower melting point than the polymer substrate 102 and the melted diluent 104 is already able to dissolve the polymer substrate 102 at a lower temperature than the melting temperature of the polymer substrate 102.

In step 110, a homogeneous solution of the polymer-diluent mixture is formed as a finished mixture. This can now be portioned in liquid form or, for example in the case of later use in the drum melter, it can be cooled directly first. For this purpose, thermal energy is extracted in step 108. The heat cycle can be closed, for example by means of heat exchangers and a recirculation step 109, so that little thermal energy is required overall during production. Finally, the ready mix is formed in solid phase in step 112 and can be converted into a ready-to-ship ready mix 120 in a portioning step 115. The ready-to-ship ready mix 120 is in a form that is very easy to handle, can be shipped, backfilled, etc. For example, the ready mix 120 is in any case uniformly distributed and homogenized over an entire batch, but can also be distributed very uniformly throughout the production process, so that the subsequent user does not first have to dose polymer substrate 102 and diluent 104 individually in his system and take into account corresponding dosing errors.

Rather, the user can fill the ready mix 120 into his system with step 125, heat or melt it with step 130 and extrude or additively manufacture a corresponding component or object 20 with step 135. The component 20 is then dried in step 140. Overall, considerably less process knowledge is therefore required for component production, so that production is now available to a much wider range of users.

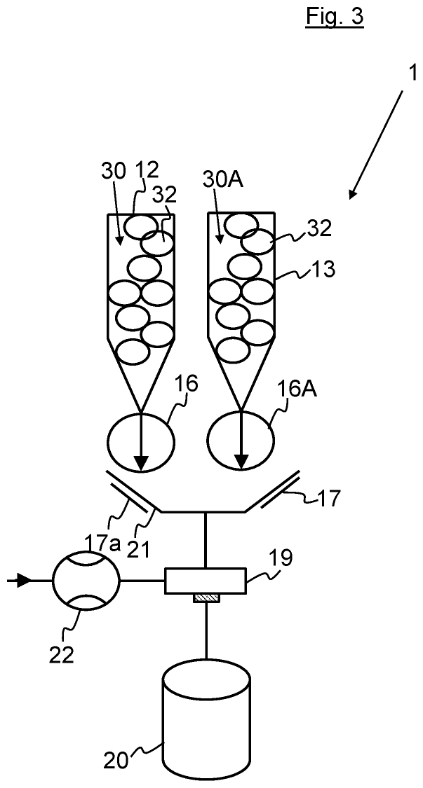

With reference to FIG. 3, a further embodiment of a system 1 for building a component 20 is shown. This figure is intended to schematically illustrate a discontinuous process. Two different ready mixes 30, 30A are provided in two storage containers 12, 13. The ready mixes 30, 30A can, for example, be provided in granular form or filament form. The ready mix 30, 30A is provided “on demand” by means of the respective dosing pump 16, 16A and transferred to the receiver 21, in which it can be heated and melted by means of the heating device 17, 17A. From this point onwards, further processing can take place, for example, in the same way as the system described in FIG. 1. Alternatively or cumulatively, the melted medium is fed to the outlet 19, whereby the outlet 19 can be designed to form a hollow thread or a thin tube 20. A supporting fluid, for example N₂, fed in a controlled manner via a flow meter 22 can prevent the extruded hollow filament or tube 20 from collapsing. Cooling causes segregation (phase separation) in the wall of the extruded hollow filament or tube 20. In this way, a component 20 can be built up piece by piece.

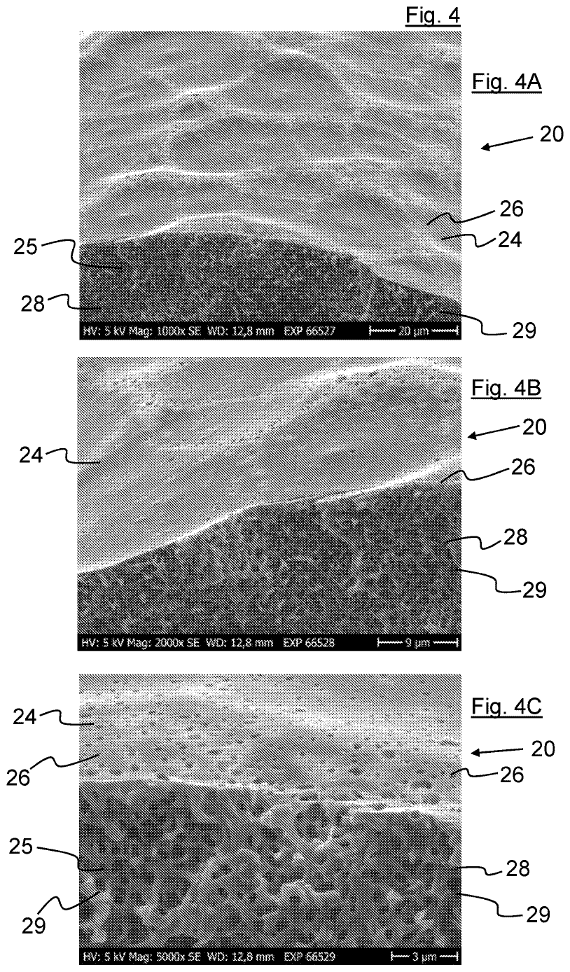

FIG. 4 shows component sections according to FIGS. 4A, 4B and 4C at different microscopic magnification levels, whereby the porosity is adjusted by means of the ready-mix 30 used. For example, FIG. 4A shows a first surface 24 of a component 20 at a magnification of 1000×, which has surface pores 26 that are connected to internal pores 29. In the porous structure 28, the numerous pores 26, 29 are predominantly connected to each other, so that a common connected cavity is formed. The component 20 thus has an open-pored structure 25.

FIG. 4B shows a further example of a component 20 produced from the ready mix 30 at 2000× magnification. In this example, too, an open-pored structure 25 of interconnected pores 26, 29 has formed. The average pore width of this design is, for example, approx. 0.5 μm. Finally, FIG. 4C shows a 5000× magnification of a detailed view of a component 20 that is quite porous in a component section 28, in which the open-pored structure 25 of the interconnected pores 26, 29 clearly stands out. In this example, the inner cavity of the interconnected pores 26, 29 is particularly evident. In other words, a self-supporting structure with intrinsic porosity is formed by the component 20. The open-pored structure 25 is permeable, i.e. it can be penetrated by material components. FIG. 4 thus provides evidence that the components produced with the ready mix 30 according to the invention can have a desired porosity if this is adjusted accordingly with the ready mix 30. Therefore, even a layperson without any special prior knowledge can produce corresponding membranes, tubes and other microporous structures or components using a simple device such as a 3D printer, without having to resort to a very complex inline mixing process.

In addition to strand extrusion and melt spinning, the material of the ready mix 30 according to the invention can also be used in the injection molding process (single and multi-component injection molding). Complex filter structures 20 can be produced cost-effectively, particularly by injection molding. Components 20 with porous and non-porous areas or with differently porous areas in the same component 20 can also be realized relatively easily in multi-component injection molding, so that the provision of the ready mix 30 according to the invention and described here in detail is seen as having enormous potential for further development in this field of work.

It is apparent to the skilled person that the embodiments described above are to be understood as exemplary and that the invention is not limited to these, but can be varied in many ways without leaving the protective scope of the claims. Furthermore, it is apparent that the features, irrespective of whether they are disclosed in the description, the claims, the figures or otherwise, also individually define essential components of the invention, even if they are described together with other features. In all figures, the same reference signs represent the same objects, so that descriptions of objects which may only be mentioned in one or at least not with respect to all figures can also be transferred to these figures and embodiments with respect to which the object is not explicitly described in the description.

### LIST OF REFERENCE SYMBOLS

1 Spinning plant
12 Storage container
13 Additional storage container for a second ready mix
14 Extruder
15 Screw conveyor or conveyor system
16, 16A Dosing pump
17, 17a Heating device
18 Extrusion nozzle
19 Outlet
20 Hollow thread, thin tube, object, component
21 Template
22 Flow meter
24 Component surface
25 open-pored or porous structure
26 Surface pore
28 Component cross-section with porous structure 25
29 Inside pore
30, 30A Ready mix
32 Granules
100 Procedure
102 Polymer substrate
104 Diluent
105 Polymer-diluent mixture
106 Supply of thermal energy
107 Melting step
108 Withdrawal of thermal energy
109 Feedback step
110 Homogeneous solution from ready mix
115 Portioning
120 Ready mix, ready for dispatch or for filling into a system
125 Filling
130 Melting the (first portion of the) ready mix
135 Production of a (first area of the) component (e.g. extrusion, continuous production, but also discontinuous production, additive manufacturing, injection molding, melt-on-demand)
140 Drying of the component (in the continuous process)
150 Melting the second portion of the ready mix or a portion of a second ready mix
155 Production of the second area of the component
160 Drying of the component (in the discontinuous process)

1-20. (canceled)

21. An easy-to-handle ready mix of a polymer preparation, such as for production of porous or microporous structures or a component, comprising:
a polymer substrate; and
a diluent,
wherein the components of the polymer preparation are interlocked in a delivery state of the ready mix such that they are inseparably bonded together.

22. The ready mix according to claim 21,
wherein the polymer preparation is in the delivery state in a solid state, and/or
wherein porous or microporous regions are formed in the polymer substrate, which are filled with diluent-rich phase.

23. The ready mix according to claim 21,
wherein the polymer preparation is in aC or less, more preferably up to 100° C. or less, and/or
wherein the polymer preparation forms a homogeneous solution at elevated temperature, wherein the elevated temperature is, for example, 70° C. or more, more preferably 90° C. or more, still more preferably 120° C. or more.

24. The ready mix according to claim 22,
the porous or microporous regions having a medium pore size,
wherein the medium pore size of the porous or microporous regions is preferably 5 μm or smaller, more preferably 1 μm or smaller, still more preferably 0.5 μm or smaller.

25. The ready mix according to claim 21,
characterized in that
the polymer substrate and/or the polymer preparation is hydrophobic and/or incorporates water only slightly, and/or
a transfer of the ready mix into a final product causes a swelling of the polymer preparation in at least one direction, preferably in all directions, of, for example, at most 10% of the original size or less, preferably 5% or less, more preferably 3% or less.

26. The ready mix according to claim 25,
characterized in that
drying of a component produced from the ready mix causes a shrinkage which is, for example, at most 10% of the original size or less, preferably 5% or less, more preferably 3% or less, and/or
wherein the shrinkage is similar in size to the swelling, so that the component produced from the ready mix has approximately the same material volume as the polymer preparation provided in the ready mix and changes in volume or length in an entire manufacturing process are less than at most 10% or less in terms of the material volume, preferably 5% or less, more preferably 3% or less.

27. The ready mix according to claim 21,
the polymer preparation further comprising an organic or inorganic additive.

28. The ready mix according to claim 21,
the polymer substrate comprising polypropylene, polyethersulfone or polyvinylidene fluoride, or a mixture thereof, and/or
the diluent comprising soybean oil, castor oil, carnauba wax, ε-caprolactam, or a mixture thereof.

29. The ready mix according to claim 21, wherein the polymer preparation comprising,
polypropylene as polymer substrate in a mass fraction of at least 20 m %, preferably at least 35 m %, more preferably at least 50 m %, and/or of up to 40 m %, preferably of up to 55 m %, more preferably of up to 65 m %, and/or
polyethersulfone as polymer substrate in a mass fraction of at least 10 m %, preferably at least 20 m %, more preferably at least 30 m %, and/or of up to 25 m %, preferably of up to 35 m %, more preferably of up to 45 m %, and/or
polyvinylidene fluoride as polymer substrate in a mass fraction of at least 15 m %, preferably at least 25 m %, more preferably at least 35 m %, and/or of up to 30 m %, preferably of up to 40 m %, more preferably of up to 50 m %, and/or
a mixture of soybean oil with castor oil as diluent in a mass fraction of at least 50 m %, preferably at least 65 m %, more preferably at least 80 m %, and/or of up to 85 m %, preferably of up to 70 m %, more preferably of up to 55 m %, and/or
carnauba wax as diluent in a mass fraction of at least 50 m %, preferably at least 65 m %, more preferably at least 80 m %, and/or of up to 85 m %, preferably of up to 70 m %, more preferably of up to 55 m %, and/or
ε-caprolactam as diluent in a mass fraction of at least 65 m %, preferably at least 80 m %, more preferably at least 90 m %, and/or of up to 95 m %, preferably of up to 85 m %, more preferably of up to 75 m %.

30. The ready mix according to claim 21 in any one of the following forms:
as granules, powder, flakes, filament, melting cartridge, a cartridge or for use in a drum melter.

31. A method for producing an easy-to-handle ready mix of a polymer preparation having a diluent,
and components of the polymer preparation are interlocked in a delivery state of the ready mix and are inseparably bonded together, the method comprising the steps of:
mixing a polymer substrate with a diluent to provide a polymer-diluent mixture,
heating the polymer-diluent mixture to a temperature above a melting temperature of the diluent,
dissolving the polymer-diluent mixture to provide a homogeneously dissolved polymer preparation,
cooling the polymer preparation below a solidification temperature, portioning the solidified polymer preparation, for example by means of granulation.

32. A method of manufacturing a component from a ready mix comprising the steps of:
providing the ready mix of a polymer preparation having a diluent, and the components of the polymer preparation are interlocked in a delivery state of the ready mix and are inseparably bonded together,
heating at least one portion of the ready mix to a temperature above a melting temperature of the diluent and/or the ready mix and thus providing a homogeneously dissolved polymer preparation,
construction of the component, such as by means of extraction of the homogeneously dissolved polymer preparation, preferably in monolithic construction, further preferably by means of additive manufacturing.

33. The method for manufacturing according to claim 32,
characterized in that, during the construction of the component up to its completion, a change in volume or length caused by foreign matter of at most 10% of the original size, preferably of at most 5% or less, more preferably of 3% or less, is effected.

34. A discontinuous method for producing a component from a ready mix, comprising the steps of:
providing a first portion of the ready mix of a polymer preparation having a diluent,
and the components of the polymer preparation are interlocked in a delivery state of the ready mix and are inseparably bonded together,
heating the first portion of the ready mix to a temperature above a melting temperature of the diluent and/or the ready mix and thus providing a first completed amount of homogeneously dissolved polymer preparation construction of a first region of the component with the first completed amount of homogeneously dissolved polymer preparation,
when the first portion of the ready mix is consumed or during consumption of the first portion of the ready mix, providing a further portion of the same ready mix or a further portion of the ready mix heating the further portion to the temperature above the melting temperature of the diluent and/or the ready mix and thus providing a second completed amount of homogeneously dissolved polymer preparation,
construction of a second region of the component with a second completed quantity of homogeneously dissolved polymer preparation.

35. A discontinuous process according to claim 34, which is carried out by means of extraction of the homogeneously dissolved polymer preparation, and/or in monolithic construction, and/or
wherein the discontinuous process is designed as an injection molding process, 3D printing, melt-on-demand or a combination thereof.

36. A plant for producing components from a ready mix of a polymer preparation having a diluent, and the components of the polymer preparation are interlocked in a delivery state of the ready mix and are inseparably bonded together, comprising:
at least one ready mix reservoir for easy provision of a solid ready mix as a first ready mix,
a heating device for heating at least one portion of the ready mix above a melting temperature of the diluent, and
a placement device such as an extruder for building up the component.

37. A plant according to claim 36,
wherein the ready mix is provided as granules and/or as a melt cartridge, and/or
wherein the at least one ready mix reservoir is provided as a drum, and
wherein the heating device is adapted to be immersed in the ready mix reservoir as a drum melter, or
wherein the ready mix is provided as a filament and the heating device is provided as a continuous melter.

38. A plant according to claim 36,
further comprising a second ready mix reservoir for providing a second ready mix different from the first ready mix.

39. A plant according to claim 36,
wherein the plant is adapted to perform a discontinuous process such as injection molding, 3D printing, melt-on-demand or a combination thereof.

40. A component produced from the ready mix of a polymer preparation having a diluent,
and the components of the polymer preparation are interlocked in a delivery state of the ready mix and are inseparably bonded together according to the method of claim 31.
